(19) United States
(12) Patent Application Publication
(10) Pub. No.: US 2022/0091841 A1
(43) Pub. Date: Mar. 24, 2022

(54) Replacement-triggered software updates

(71) Applicant: Hewlett-Packard Development Company, L.P., Spring, TX (US)

(72) Inventors: Albert Serra Junyent, Singapore (SG); Jan Morovic, London (GB); Tuomo Eljas Kaikkonen, Sant Cugat del Valles (ES); Juan Ignacio Zurbano Fernandez, Sant Cugat del Valles (ES); Jorge Castano Aspas, Sant Cugat del Valles (ES)

(73) Assignee: Hewlett-Packard Development Company, L.P., Spring, TX (US)

(21) Appl. No.: 17/419,114

(22) PCT Filed: Jun. 10, 2019
(86) PCT No.: PCT/US2019/036245

§ 371 Date: Jun. 28, 2021

(51) Int. Cl. G06F 8/654; G06F 3/12

(52) U.S. Cl. CPC G06F 8/654; G06F 3/123; G06F 3/1203

(57) ABSTRACT

Disclosed herein is a consumable item for a device, a printing device, and a method of operating a device. The consumable item for a device is to be removably inserted into the device and comprises a machine-readable storage medium that contains update information identifying a version of a software for the device.

### BACKGROUND

A device, like a printer, uses software for a microcontroller or a driver which may be located internally or at a computer connected to the device. A new version of the software may be provided, e.g. to optimize performance, to provide a new functionality or to fix a bug. A version of the software on the device or the computer may be updated by installing the new version.

### BRIEF DESCRIPTION OF DRAWINGS

In the following, a detailed description of various examples is given with reference to the figures. The figures show schematic illustrations of

FIG. 1: a consumable item for a device in accordance with an example;

FIG. 2a: an ink cartridge for a printing device according to an example;

FIG. 2b: a machine-readable storage medium of the ink cartridge of FIG. 2a in accordance with an example;

FIG. 3: a device in accordance with an example;

FIG. 4: a printing device according to an example;

FIG. 5: a method of operating a device according to an example; and

FIG. 6: another method of operating a device in accordance with an example.

### DETAILED DESCRIPTION

A device with internet connectivity may check for available updates for a software via the internet and may notify a user about an available update or may automatically download and install the update. For a device that is not connected to the internet, e.g. due to a lack of internet connectivity or because the user chooses to not connect the device to the internet, the user may manually check for and install available updates. This may delay the deployment of a new version of the software, which may contain critical bug fixes or ensure compatibility with future changes.

A device such as a printer may use a consumable item like an ink cartridge. The consumable item may be replaced by the user on a regular basis, e.g. whenever the ink cartridge is empty. Information on a current version of a software may be encoded in the consumable item. Thereby, the consumable item may be used to inform the user about the availability of a new version of the software and to trigger an update of the software.

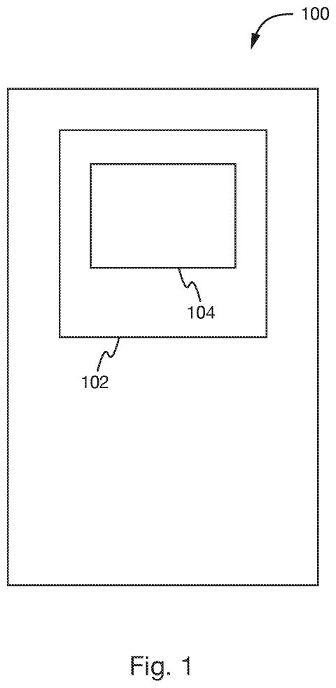

FIG. 1 depicts a consumable item 100 for a device (not shown) according to an example. The consumable item 100 may for example be a consumable supply item, e.g. a consumable supply item for a printing device like an ink cartridge or a toner cartridge. Alternatively, the consumable item 100 may be another replacement part for a printing device, e.g. a maintenance cartridge, a wiper, a waste receptacle or a cutter. In other examples, the consumable item 100 may be a consumable item for a different type of device and may e.g. be a battery, a filter, a gas cartridge or a waste tank such as a vacuum cleaner bag. More generally, a consumable item may be any replacement part which can be replaced by a user, e.g. a replacement part that typically has a shorter lifetime or usage time than the respective device and may thus be replaced on a regular basis.

The consumable item 100 is to be removably inserted into the device, e.g. such that the consumable item can be replaced by a user. The consumable item 100 may be mounted in the interior of the device or may be attached to an outer side of the device. The consumable item 100 and/or the device may comprise a fastener like a screw, a pin, a clip or a hook, e.g. such that the consumable item 100 may be inserted, held and removed from the device without using a tool in one example.

The consumable item 100 comprises a machine-readable storage medium 102. The storage medium 102 may for example be an EEPROM chip or a flash memory. The storage medium 102 contains update information 104 that identifies a version of a software, in particular a software for the device. The software may for example be a firmware for a microcontroller in the device or a software for a computing apparatus that is to be connected to the device, e.g. a driver for the computing apparatus to communicate with and/or control the device. In some examples, the consumable item 100 may additionally comprise a microcontroller (not shown), e.g. a microcontroller that is to read out the storage medium 102 and/or write on the storage medium 102 as well as to exchange data with a device that the consumable item 100 is inserted in. Exchange of data with the storage medium 102 and/or with the microcontroller may be performed in a wired or a wireless manner, e.g., if the storage medium 102 is part of an RFID chip or comprises wireless communications means.

The update information 104 may e.g. contain an identifier such as a version number that identifies the version of the software, wherein the version number may for example be a number, e.g. “1”, “2”, or “3”, or a string, e.g. “v1.0”, “v1.1”, “v1.2” or “v2.0”. In other examples, the identifier may e.g. be a release date of the version of the software. The update information 104 may contain additional information on the version. The update information 104 may for example indicate whether the version is a mandatory or non-mandatory update. In some examples, the update information 104 specifies that the version identified by the update information 104 is a mandatory minimum version of the software, e.g. if the version identified by the updated information 104 contains a critical bug fix or if versions older than the version identified by the update 104 are not compatible with the consumable item 100 or with a future modification, e.g. an upcoming version of the software or a modification planned for a consumable item such as the consumable item 100. Alternatively or additionally, the update information 104 may also identify a current version of the software, e.g. the latest version of the software when the consumable item 100 was manufactured. In one example, the storage medium 102 may also contain the software itself or a part thereof or another software such as an installer that is to download and install the version of the software from the internet.

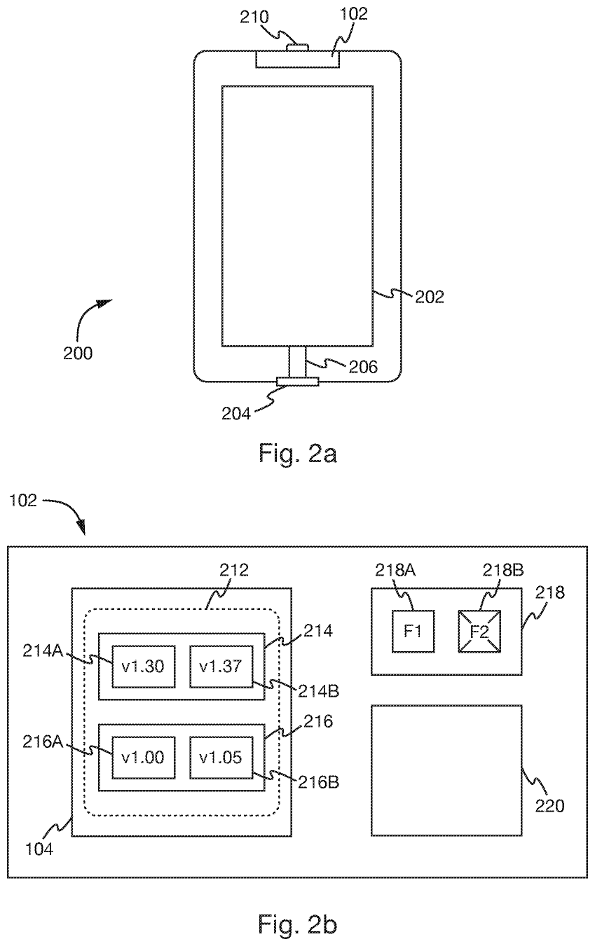

FIG. 2a shows an ink cartridge 200 for a printing device (not shown) according to an example. The ink cartridge 200 is an example for a consumable item and the features described in the following may also be present in other consumable items for a printing device or a different type of device, e.g. the consumable item 100. Similar to the consumable item 100, the ink cartridge 200 also comprises a machine-readable storage medium 102, which is illustrated in FIG. 2b.

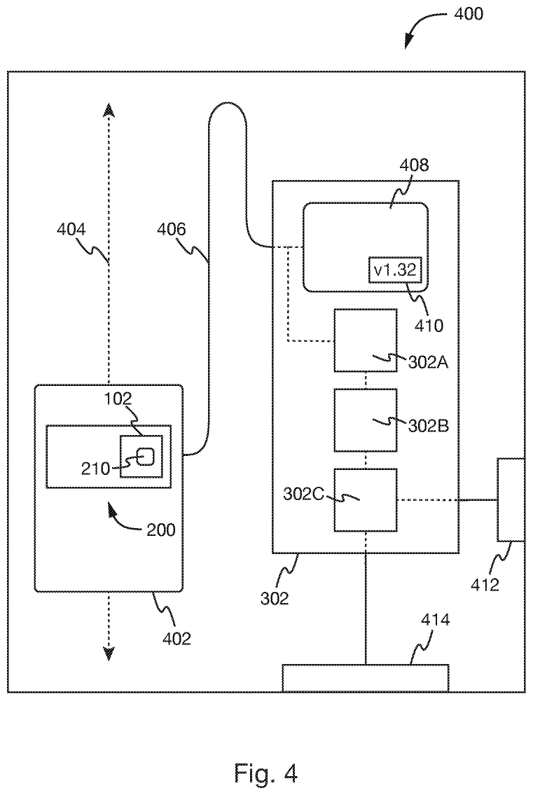

The ink cartridge 200 may comprise an ink tank 202 that is to store a print fluid such as ink. The ink tank 202 may be connected to an output port 204 through a tube 206, wherein the output port 204 may be to provide a connection for the print fluid between the ink cartridge 200 and the printing device, for example a print head of the printing device as discussed below with reference to FIG. 4. In some examples, the ink cartridge 200 may further comprise a mounting structure (not shown) like a fastener to attach the ink cartridge 200 to the printing device, for example hooks or clips to be inserted into corresponding recesses in the printing device. The ink cartridge 200 may also comprise an electrical contact pad 210 that is arranged on an outer surface of the ink cartridge 200, e.g. a side surface or a top surface as shown in FIG. 2a. The electrical contact pad 210 is to provide an electrical connection between the storage medium 102 and the printing device when the ink cartridge 200 is inserted in the printing device. The electrical contact pad 210 may for example comprise a metallic contact that is electrically connected to the storage medium 102 and that is to come in contact with a metallic contact of the printing device when the ink cartridge 200 is inserted in the printing device.

The storage medium 102 of the ink cartridge 200 is similar to the storage medium 102 of the consumable item 100 and also stores update information 104 that identifies a version of a software, e.g. a firmware for the printing device or a printer driver for a computing apparatus that is to be connected to the printing device. In the example of FIG. 2b, the update information 104 comprises an update table 212, which contains version information 214 for a first software for a first type of device and version information 216 for a second software for a second type of device. In one example, the first software may be a firmware for the printing device and the second software may be a driver for a computing apparatus that is to be connected to the printing device. In another example, the ink cartridge 200 may be compatible with multiple types of printing devices and the first software may be a firmware for a first type of printing device, e.g. a first model, and the second software may be a firmware for a second type of printing device, e.g. a second model. In other examples, the update table 212 may contain version information for a plurality of software and for a plurality of devices, e.g. firmware and drivers for more than 10 types of printing devices, wherein the drivers may furthermore be or comprise drivers for a plurality of operating systems.

The version information 214 for the first software may comprise version information 214A identifying a mandatory minimum version of the first software, in this example version “v1.30”, and/or version information 214B identifying a current version of the first software, in this example version “v1.37”. Accordingly, the version information 216 for the second software may comprise version information 216A identifying a mandatory minimum version for the second software, in this example version “v1.00”, and/or version information 216B identifying a current version of the second software, in this example version “v1.05”. As described above, a version that is older than the mandatory minimum version may for example not be compatible with the ink cartridge 200 or a planned modification of an ink cartridge such as the ink cartridge 200, e.g. due to a modified ink composition. Parameters of the printing device may e.g. be adjusted to a specific ink composition to optimize the printing or to prevent clogging of the printing device.

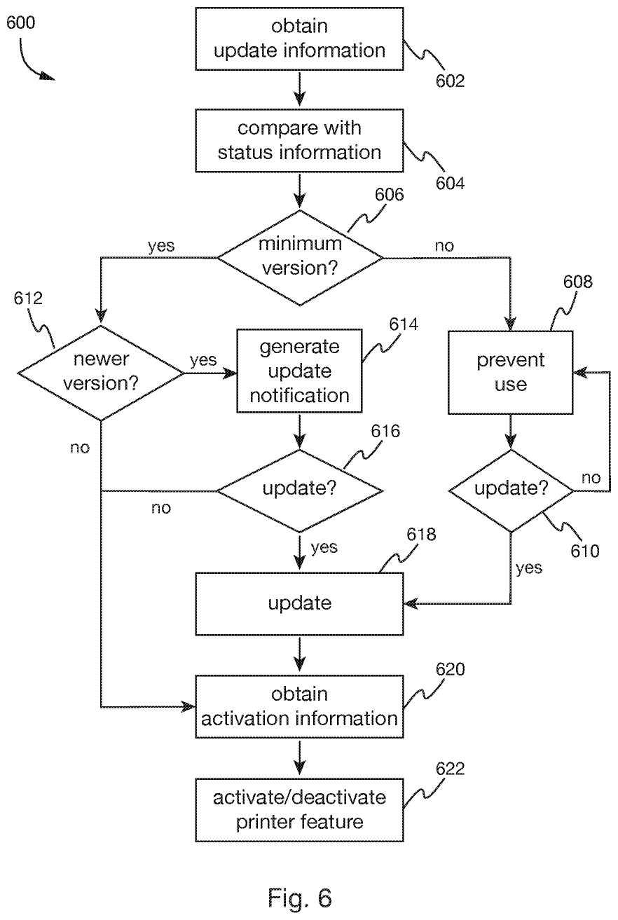

The storage medium 102 may further store activation information 218 that identifies a feature of the printing device that is to be activated or deactivated, e.g. activation information 218A for a first feature and activation information 218B for a second feature. The activation information 218 may for example comprise an identifier for the feature, e.g. a string such as “F1” or “F2” or a number, as well as a variable characterizing whether that feature is to be activated or deactivated. In FIG. 2b, a white square indicates that the corresponding feature is to be activated, in this example the feature “F1”, whereas a crossed-out square indicates that the corresponding feature is to be deactivated, in this example the feature “F2”. In this way, the ink cartridge 200 may serve as a dongle for unlocking or locking a feature, wherein the feature may for example be unlocked while the ink cartridge 200 is inserted in the printing device or may be unlocked indefinitely once the ink cartridge 200 is inserted in the printing device, e.g. as described in more detail below with reference to FIG. 6.

The storage medium 102 may further store additional information 220, which may for example contain information on the ink cartridge, e.g. a color, type or amount of ink contained in the ink tank 202, a serial number or a list of compatible printing devices. In some examples, the storage medium 102 may be a rewritable storage medium, e.g. such that the additional information 220 may be updated, for example to keep track of the amount of ink in the ink tank 202.

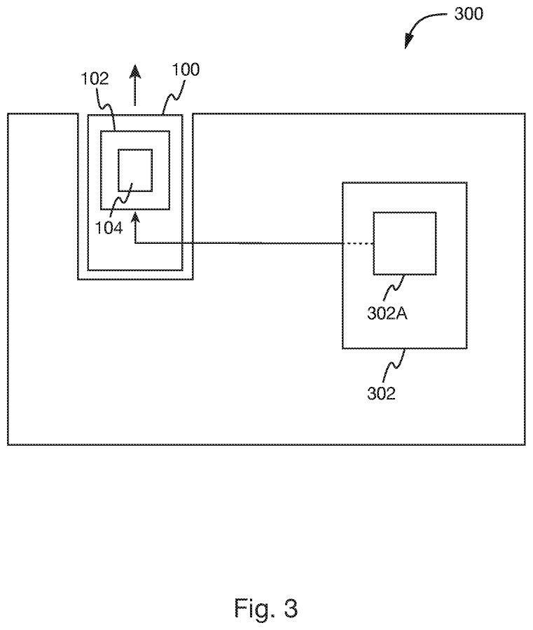

FIG. 3 illustrates a device 300 in accordance with an example. The device comprises a controller 302, which may for example include a processor (not shown) and a storage medium (not shown). The storage medium in the controller 302 may store a set of instructions that, when executed by the processor of the controller 302, provide the functionality of the controller 302 described in the following. The controller 302 may comprise a module, e.g. a read-out module 302A detailed below, wherein a module of the controller 302 may be implemented in software, hardware or a combination thereof. A module of the controller 302 may for example correspond to a set of instructions for the processor of the controller 302. Alternatively or additionally, the controller 302 may e.g. comprise an electronic circuit that is to provide the functionality of the module or a part thereof. The controller 302 may in particular be to execute the method 500 and/or the method 600 described below or parts thereof.

The device 300 is to receive a replaceable component having a machine-readable storage medium, for example the consumable item 100 with the machine-readable storage medium 102 storing the update information 104. In the following, the device 300 is described using the consumable item 100 as an example. This is, however, not intended to be limiting in any way and the device 300 may be to receive another replaceable component with a storage medium, e.g. the ink cartridge 200.

The controller 302 comprises the read-out module 302A that is to obtain version information from the machine-readable storage medium 102 when the consumable item 100 is inserted in the device 300. The version information identifies an updated version of a software, e.g. a software for the device 300 or a device that is to be connected to the device 300, e.g. a computing apparatus. The read-out module 302A may for example obtain the version information by reading out the update information 104 from the storage medium 102. The version information may be the update information 104 or a part thereof or may be obtained from the update information 104, e.g. by extracting a value of a variable contained in the update information 104, e.g. a version number. The read-out module 302A may for example be to obtain the version information whenever a consumable item is inserted into the device 300.

In some examples, the controller 302 may be to process the version information, e.g. by comparing the version identified by the version information to a version of the software that is installed on the device 300 as described below with reference to FIG. 4. In other examples, the controller 302 may be to provide the version information to a device that is connected to the controller 302, e.g. a computing apparatus.

FIG. 4 depicts a printing device 400 according to an example. The printing device 400 is to receive a replaceable component with a machine-readable storage medium. As detailed in the following, the printing device 400 may for example be an inkjet printer that is to receive a replaceable ink cartridge, e.g. the ink cartridge 200. In other examples, the printing device 400 may e.g. be to receive a replaceable service cartridge, a replaceable wiper, a replaceable waste receptacle or a replaceable cutter. In yet another example, the printing device 400 may e.g. be a laser printer that is to receive a replaceable toner cartridge.

The printing device 400 may be to distribute a print fluid such as ink on a print medium, e.g. paper. For this, the printing device 400 may comprise a print head 402 that is movable along a print head path 404, e.g. using an electric motor. In one example, the printer may be a 3D printer, wherein the print head 402 may be movable along two or three directions. The print head 402 may be to receive the ink cartridge 200. The print head 402 may for example comprise a slot (not shown) that the ink cartridge 200 can be inserted in. The print head 402 may further comprise a nozzle plate (not shown) with nozzles for distributing the print fluid, wherein the nozzles may be connected to the output port 204 of the ink cartridge 200 to receive the print fluid from the ink tank 202.

The printing device 400 further comprises a controller 302, which may include a processor (not shown) and a storage medium (not shown) similar to the controller 302 of the device 300. The controller 302 of the printing device 400 may in particular be to execute the method 500 and/or the method 600 described below or parts thereof. The controller 302 also includes a read-out module 302A that is to obtain version information identifying an updated version of a software from the storage medium 102 when the ink cartridge 200 is inserted in the printing device 400, e.g. as described above with reference to FIG. 3. The read-out module 302A may for example be to read out the version information 214B identifying a current version of the firmware from the update table 214 on the storage medium 102. The controller 302 may be connected to the print head 402 via a cable 406, wherein the print head 402 is to provide an electrical connection between the cable 406 and the contact pad 210 of the ink cartridge 200. In other examples, the controller 302 or a part thereof, e.g. the read-out module 302A, may be integrated into the print head 402.

The controller 302 may further be to control operation of the printing device 400 and in particular of the print head 402, e.g. via the cable 406. In other examples, the printing device 400 may comprise a main controller for controlling operation of the printing device 400 that is separate from the controller 302. The controller 302 may for example be to receive a print job from a computing apparatus (not shown) connected to the printing device 400 and to execute the print job using the print head 402. For this, the controller 302 may comprise a firmware 408, which may e.g. include a set of instructions to provide the respective functionality of the controller 302. In some examples, the read-out module 302A or other modules of the controller 302 may be integrated in the firmware 408. In the following, the firmware 408 is used as an example of a software of which an updated version is identified by the version information obtained from the storage medium 102. In other examples, the software of which an updated version is identified by the version information obtained from the storage medium 102 may e.g. be a firmware for the main controller, a driver for a computing apparatus that is to be connected to the printing device 400 or another software for the computing apparatus, e.g. a software providing a graphical user interface for controlling the printing device 400 or performing maintenance operations on the printing device 400.

The read-out module 302A may further be to obtain status information 410 that identifies an installed version of the firmware 408, wherein the status information 410 may for example be or comprise a version number of the installed version. The controller 302 may further comprise a comparison module 302B that is to compare the status information 410 to the version information identifying the updated version of the firmware 408. The comparison module 302B may for example be to determine whether the updated version is different from the installed version based on the comparison between the status information and the version information. The comparison module 302B may in particular be to determine whether the updated version is newer than the installed version, e.g. whether a version number of the updated version is larger than a version number of the installed version or a release date of the updated version is later than a release date of the installed version. In the example of FIGS. 2b and 4, the status information 410 may for example indicate that the version number of the installed version is “v1.32”, whereas the version information 214B may indicate that the version number of the current version is “v1.37”, i.e. the current version may be newer than the installed version.

In some examples, the read-out module 302A may also be to obtain a minimum version requirement from the storage medium 102, e.g. by reading out the version information 214A identifying the mandatory minimum version of the software from the update table 214. The comparison module may further be to determine whether the installed version meets the minimum version requirement, e.g. by comparing the version number of the installed version obtained from the status information 410 to a version number specified by the version information 214A. In the example of FIGS. 2b and 4, the mandatory minimum version may e.g. be “v1.30”, i.e. the installed version may be newer than the mandatory minimum version and may thus meet the minimum version requirement. In another example, the installed version may e.g. be “v1.14” and the mandatory minimum version “v1.30”, i.e. the installed version may be older than the mandatory minimum version and may thus not meet the minimum version requirement. In some examples, the controller 302 may be to prevent use of the ink cartridge 200 and/or to interrupt operation of the printing device 400 if the installed version does not meet the minimum version requirement, e.g. until an update of the firmware 408 is performed.

The controller 302 may comprise a notification module 302C that is to generate an update notification, e.g. if the comparison module 302B determines that the updated version is newer than the installed version and/or that the installed version does not meet the minimum version requirement.

The printing device 400 may comprise a connection interface 412 that is to provide a connection between the printing device 400 and another device, e.g. a computing apparatus (not shown). The connection interface 412 may for example comprise a USB port, a LAN port, a Bluetooth antenna and/or a WiFi antenna. The notification module 302C may for example send an update notification to the computing apparatus using the connection interface 412, e.g. to a driver for the printing device running on the computing apparatus. The update notification may comprise information indicating whether the updated version is different from the installed version and/or whether the installed version meets the minimum version requirement. The update notification may trigger the driver to inform a user about the availability of an update for the firmware 408, e.g. by displaying a corresponding message on a display of the computing apparatus. Alternatively or additionally, the driver may be to automatically try to obtain an update for the software from a web server upon receiving the update notification. If the update notification indicates that the installed version does not meet the minimum version requirement, the driver may prevent use of the ink cartridge 200 and/or may interrupt operation of the printing device 400, e.g. until an update of the firmware 408 is performed. In some examples, the controller 302 itself may try to obtain an update for the firmware 408 from a web server via the connection interface 412 if the comparison module 302B determines that the updated version is newer than the installed version and/or that the installed version does not meet the minimum version requirement.

The printing device 400 may further comprise a user interface 414, which may e.g. include a display and/or a status LED. The notification module 302C may be to send an update notification to the user interface 414, e.g. to activate a status LED or to display a message to corresponding to the update notification on the display. The user interface 414 may also comprise an input device that is to receive a user input, e.g. a button or a touchscreen.

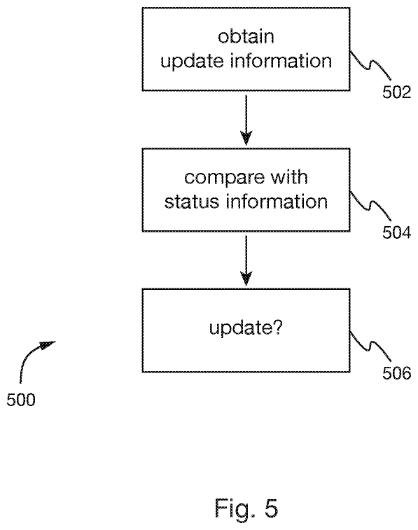

FIG. 5 shows a flowchart of a method 500 of operating a device according to an example. The device is to receive a consumable item containing update information identifying an updated version of a software. The method 500 may for example be executed using the printing device 400, e.g. when the ink cartridge 200 containing update information 104 for the firmware 408 is inserted into the printing device 400, and is explained in the following with reference to FIG. 4. This is, however, not intended to be limiting in any way and the method 500 may be executed with any another device that is to receive a consumable item containing update information identifying an updated version of a software, e.g. the device 300.

The method 500 comprises, at block 502, obtaining the update information from the consumable item, e.g. by reading out the update information 104 or a part thereof, for example the version information 214B or the version information 214 for the firmware 408 of the printing device 400, from the storage medium 102 of the ink cartridge 200 using the read-out module 302A. For this, the read-out module 302A may establish a connection to the storage medium 102 and may read out data from the storage medium 102. Block 502 may comprise determining which version information from the update table 212 is associated with a model type of the printing device 400 and obtaining the respective version information or a part thereof. Block 502 may also comprise testing the functionality of the storage medium 102, e.g. to confirm that the storage medium 102 and/or the ink cartridge 200 is operational, and reading out other information, e.g. the activation information 218 or the additional information 220 to confirm that the ink cartridge 200 is compatible with the printing device 400 or to obtain an ink level of the ink cartridge 200.

The method 500 further comprises, at block 504, comparing the update information to status information identifying an installed version of the software that is installed on the device or a computing apparatus connected to the device. The comparison module 302B may for example compare a version number of a current version extracted from the version information 214B to a version number extracted from the status information 410 of the firmware 408. Additionally or alternatively, the comparison module 302B may e.g. compare the version number extracted from the status information 410 to the version number of the mandatory minimum version extracted from the version information 214A.

The method 500 also comprises, at block 506, determining whether an update of the installed version is to be performed based on the comparison of the update information and the status information. In some examples, it may be determined that an update is to be perm formed if the version number of the installed version is smaller than the version number of the current version. In the example of FIGS. 2b and 4, the version number of the installed version is “v1.32” and is thus smaller than the version number “v1.37” of the current version. Accordingly, it may be determined in block 506 that an update of the installed version is to be performed. In other examples, it may be determined that an update is to be performed if the version number of the installed version is smaller than the version number of the mandatory minimum version. In the example of FIGS. 2b and 4, the version number of the installed version is “v1.32” and is thus larger than the version number “v1.30” of the mandatory minimum version. Accordingly, it may be determined in block 506 that an update of the installed version is not to be performed. Block 506 may further comprise generating an update notification if it is determined that an update is to be performed, e.g. as detailed below with reference to FIG. 6.

FIG. 6 depicts a flowchart of another method 600 of operating a device in accordance with an example, wherein the device is to receive a consumable item containing update information identifying an updated version of a software. The method 600 may for example also be executed using the printing device 400, e.g. when the ink cartridge 200 containing update information 104 for the firmware 408 is inserted into the printing device 400, and is explained in the following with reference to FIGS. 4 and 6. This is, however, not intended to be limiting in any way and the method 600 may be executed with any another device that is to receive a consumable item containing update information identifying an updated version of a software, e.g. the device 300.

The method 600 comprises, at block 602, obtaining the update information from the consumable item, e.g. as described above for block 502 of method 500. The update information may in particular comprise a minimum version requirement, which may e.g. be specified by the version information 214A identifying a mandatory minimum version of the firmware 408. The update information may further comprise version information 214B identifying a current version of the firmware 408.

At block 604, the update information obtained in block 602 is compared to status information identifying an installed version of the software, e.g. the status information 410 identifying the installed version of the firmware 408. This may in particular comprise comparing the status information 410 to the version information 214A as well as to the version information 214B. Block 604 may further comprise obtaining the status information, e.g. by reading out the version number of the firmware 408.

Subsequently, at block 606, it may be determined whether the installed version meets the minimum version requirement obtained from the update information, e.g. by determining whether the version number of the installed version of the firmware 408 is larger than the version number specified by the version information 214A based on the comparison performed in block 604. If the minimum version requirement is not met, the method 600 may proceed to block 608. Otherwise, the method 600 may proceed to block 612.

If the minimum version requirement is not met, the method 600 may comprise, at block 608, preventing use of the replaceable component, e.g. the ink cartridge 200. In some examples, block 608 may also comprise interrupting operation of the printing device 400, e.g. preventing execution of a current print job and/or a new print job. Block 608 may also comprise generating an update notification to inform a user about the availability of an update or to trigger execution of an update, e.g. as in block 614 described below.

In some examples, the method 600 may comprise, at block 610, asking the user whether an update is to be performed, e.g. by downloading the corresponding installer from a web server. If the user decides not to perform the update, method 600 may return to block 608, e.g. to continue to prevent use of the ink cartridge 200 and/or to generate a new update notification. Otherwise, the method 600 may proceed to block 618 described below. In other examples, block 610 may comprise trying to obtain the update automatically, e.g. by trying to establish a connection to a web server and downloading the corresponding installer. The controller 302 may try to obtain the update, e.g. via the communication module 302C and the connection interface 412. Alternatively, a computing apparatus connected to the printing device 400 may try to obtain the update, e.g. by triggering the driver on the computing apparatus via an update notification generated in block 608. If the update cannot be obtained, for example because the attempt to establish the connection to the web server fails, the method may return to block 608. Otherwise, the method may proceed to block 618.

If the minimum version requirement is met, the method 600 may comprise, at block 612, determining whether a newer version of the software is available, e.g. based on the comparison of the status information 410 and the version information 214B. If the current version of the firmware 408 characterized by version information 214B is more recent than the installed version, the method 600 may proceed to block 614. Otherwise, the method 600 may directly proceed to block 620.

At block 614, an update notification may be generated, e.g. using the communication module 302C. In one example, the update notification is sent to the user interface 414 to display a message on a display of the user interface 414 informing about the availability of a non-mandatory update. In another example, the update notification is sent to a computing apparatus via the connection interface 412 to display a corresponding message on a display of the computing apparatus. The update notification may further comprise information on the available update, e.g. the version information 214B, and may specify selection options for the user, e.g. to perform the update now, to perform the update later or to skip the update.

At block 616, the method may comprise asking the user whether an update should be performed, e.g. based on the update notification via the display of the user interface 414 or the computing apparatus. If the user decides to perform the update, the method 600 proceeds to block 618. If not, the method 600 proceeds to block 620. Additionally or alternatively, block 616 may comprise trying to obtain the update, e.g. as described above for block 610. If the update cannot be obtained, the method may proceed to block 620. Otherwise, the method may proceed to block 618.

The method 600 may further comprise, at block 618, performing the update, e.g. by executing the corresponding installer. The installer may replace the installed version by a new version, e.g. the updated version or an even newer version if available. If the installer has not been obtained yet, block 618 may comprise obtaining the installer, e.g. by downloading it from a web server. In some examples, this may comprise providing the installer to the printing device on a physical storage medium such as an USB flash storage or an SD card, e.g. in cases in which the connection interface 412 may not be fully operational while performing the update of the firmware 408.

In some examples, the method 600 may also comprise, at block 620, obtaining activation information from the consumable item, wherein the activation information identifies a feature of the device that is to be activated or deactivated. At block 622, the respective feature may be activated or deactivated accordingly. A feature may for example be activated or deactivated for as long as the consumable item remains in the device or for a predetermined period of time, e.g. a trial period specified by the activation information. In other examples, the feature may be activated or deactivated until a consumable item is inserted with activation information indicating that the corresponding future is to be deactivated or activated, respectively.

The activation information may for example be obtained by reading out activation information 218 from the storage medium 102 of the ink cartridge 200 using the read-out module 302C. In the example of FIG. 2b as described above, the activation information 218 may indicate that the feature “F1” is to be activated, while the feature “F2” is to be deactivated. The cartridge 200 may e.g. be a special cartridge that is provided when the feature “F1” is purchased by a user in order to update the firmware 408 of the printing device 400 accordingly. In one example, the feature “F1” may be that the printing device 400 accepts a certain type of ink cartridge, for example ink cartridges supplied as part of a subscription model or contract. Alternatively, the feature “F1” may be a feature provided together with a certain type of a regular ink cartridge, e.g. a feature that is compatible with the ink cartridge 200, but not compatible with other types of ink cartridges. Accordingly, the feature “F2” may for example be a feature that is not compatible with the ink cartridge 200. The feature “F2” may e.g. be printing on a certain type of substrate if the ink cartridge 200 contains a print fluid that is not suitable for this type of substrate.

This description is not intended to be exhaustive or limiting to any of the examples described above. The consumable item, the printing device, and the method operating advice disclosed herein can be implemented in various ways and with many modifications without altering the underlying basic properties.

1. A consumable item for a device, wherein:
the consumable item is to be removably inserted into the device;
the consumable item comprises a machine-readable storage medium; and
the storage medium contains update information identifying a version of a software for the device.

2. The consumable item of claim 1, wherein the update information specifies the version of the software as a mandatory minimum version of the software.

3. The consumable item of claim 2, wherein the update information further identifies a current version of the software.

4. The consumable item of claim 1, wherein the software is a firmware for the device or a driver for a computing apparatus that is to be connected to the device.

5. The consumable item of claim 1, wherein the update information identifies a version of a first software for a first type of device and a version of a second software for a second type of device.

6. The consumable item of claim 1, wherein the storage medium further contains activation information identifying a feature of the device that is to be activated or deactivated.

7. The consumable item of claim 1, further comprising an electrical contact pad on an outer surface of the consumable item, wherein the electrical contact pad is to provide an electrical connection between the storage medium and the device when the consumable item is inserted in the device.

8. A printing device comprising a controller, wherein:
the printing device is to receive a replaceable component having a machine-readable storage medium; and
the controller comprises a read-out module that is to obtain version information identifying an updated version of a software from the machine-readable storage medium when the replaceable component is inserted in the printing device.

9. The printing device of claim 8, wherein
the read-out module is further to obtain status information identifying an installed version of the software that is installed on the printing device or a computing apparatus connected to the printing device; and
the controller comprises a comparison module that is to compare the version information to the status information to determine whether the updated version is different from the installed version.

10. The printing device of claim 9, wherein
the read-out module is further to obtain a minimum version requirement from the machine-readable storage medium; and
the comparison module is to determine whether the installed version meets the minimum version requirement.

11. The printing device of claim 10, wherein the controller is to prevent use of the replaceable component if the installed version does not meet the minimum version requirement.

12. A method of operating a device, wherein the device is to receive a consumable item containing update information identifying an updated version of a software, the method comprising:
obtaining the update information from the consumable item;
comparing the update information to status information identifying an installed version of the software that is installed on the device or a computing apparatus connected to the device; and
determining whether an update of the installed version is to be performed based on the comparison of the updated information and the status information.

13. The method of claim 12, wherein
the update information comprises a minimum version requirement; and
comparing the update information to the status information comprises determining whether the installed version meets the minimum version requirement.

14. The method of claim 12, further comprising generating an update notification if an update of the installed version is to be performed.

15. The method of claim 12, further comprising:
obtaining, from the consumable item, activation information identifying a feature of the device that is to be activated or deactivated; and
activating or deactivating the feature identified in the activation information.
